(19) United States
(12) Patent Application Publication
(10) Pub. No.: US 2005/0059365 A1
(43) Pub. Date: Mar. 17, 2005

(54) Mounting bracket for a radio frequency communications device

(76) Inventors: Sidney Arch Higgins, Maple Grove, MN (US); Allen Eugene Rogers, Owatonna, MN (US); Janet M. Penz, Lakeville, MN (US); Gerald Henry Janish, Janesville, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/909,548

(22) Filed: Aug. 2, 2004

Related U.S. Application Data
(60) Provisional application No. 60/502,911, filed on Sep. 15, 2003.

(51) Int. Cl. H04B 1/00; H04B 1/02

(52) U.S. Cl. 455/128; 455/575.1; 455/91

(57) ABSTRACT

A unitary one-piece mounting bracket for mounting a meter transponder at the top of a rod or tube in connection with utility meters that are located in subsurface pit enclosures. The mounting bracket includes multiple blind receptacles to receive the rod or tube and supports the transponder without the need for removable fasteners.

### CLAIM TO PRIORITY

This application claims priority to U.S. Provisional Patent Application Ser. No. 60/502,911 filed Sep. 15, 2003 entitled Mounting Bracket for Radio Frequency Communications Device the entire contents of which application are incorporated herein by this reference.

### FIELD OF THE INVENTION

The invention relates to the placement and support of an RF transmitter assembly used in connection with utility meters that are located in subsurface or pit enclosures.

### BACKGROUND

Utility meters are often located in underground enclosures that are commonly called “pits.” An exemplary meter pit is depicted in FIG. 11. In the southern United States, particular water meters are often located in pits. The theory of locating water meters in pits is that that the water service line is located beneath the lowest frost line, where the earth temperature never falls below the freezing point of water. The bottom of the pit is also located beneath the frost line so that warm air from the above freezing temperature earth rises and maintains the temperature in the enclosure above the freezing point at all times. Thus, the temperature in the pit enclosure remains above freezing and water will continue to flow in the pipes even if the surface temperature of the soil is below freezing.

Traditionally, usage data from utility meters was gathered by having a human meter reader visit each individual utility meter, visually read utility usage information from the face of the meter and manually record utility usage information. In the case of pit mounted meters, this task requires removing a protective covering, similar to a small manhole cover, from the pit in order to access the meter. When the meter is not being read, the protective cover is returned to the pit opening in order to protect the meter from the elements as well as from such activities as lawn mowing and to keep passersby from stumbling into the opening.

A pit is typically a bottomless can with a lid that is buried in the ground so that the top of the can and lid are at approximately ground level. A pit enclosure is often made of cast iron but may be formed from plastics or other materials. Thus a pit has a removable lid and vertical sides to protect the enclosed meter. The bottom is formed of the earth.

In recent years, more and more utility reading is being performed remotely. In this approach, a radio frequency transmitter is connected to the utility meter and transmits signals representing meter consumption information to either a mobile or fixed collection unit so that it becomes unnecessary for a meter reader to individually access each individual utility meter. To function properly, a radio frequency transmission module that is coupled to a utility meter installed in a pit, generally should be located just slightly below ground level, so that its top is close to and parallel with the lid of the pit. The radio frequency transmission module generally should not touch the pit structure for it to function properly. This creates a problem when installing radio frequency transmission modules in existing pit installations which were not designed when originally installed to accommodate a radio frequency transmission module within the pit. At the time of this application, a large fraction of meter pits exist that were not designed for use with a radio frequency transmission module.

Typically, these radio frequency transmitters have been mounted in the pit beneath the pit cover, attached to a rod or pipe, usually of metal or polyvinyl chloride, and driven vertically into the ground that forms the floor or bottom of the pit. It is desirable for the transmitter module to remain at a constant elevation during the life of the installation. Therefore, it is desired that the transmitter module be attached to the rod in such a way that it will not slip down the length of the rod under the influence of gravity. Problems have occurred with transmitters clamped to the rod slipping or moving due to the failure of clamping mechanisms. In particular, an installation that is clamped securely to a rod may become loose because of changes in temperature. Thus, there is a need in the art for a device to secure a transmitter module to a rod and to maintain its location over a long period of time.

Further, screws and bolts used in clamping mechanisms and metallic rods are subject to corrosion over time in the high humidity environment of a meter pit. This can eventually lead to failure of the clamp or require the use of expensive stainless steel hardware to prevent corrosion. Screw based clamps also generally include screws, bolts and nuts or wing nuts. These small pieces of hardware are prone to easy loss if separated from the clamp. This can be especially inconvenient if the hardware is dropped into the pit where the bottom may be too deep for the installer to reach to retrieve the hardware.

In addition, rods or poles upon which radio frequency transmitter modules may be mounted may vary in size from installation to installation. It is common for the rod to vary from three eighth inch concrete reinforcing bar (rebar) to bars or tubes of up to about seven eighths of an inch in diameter. Small diameter concrete reinforcing rods are often used for this purpose, such as three eighths or half-inch rebar. Half-inch schedule 40 PVC pipe is also commonly used. Half inch pipe is designated based on its inside diameter. Its out side diameter is significantly larger. There is a need to accommodate these multiple sized rods in the installation process.

A further problem with existing ways of securing radio frequency transmitters to rods is that the securing assembly may be assembled improperly. This will require the installer to disassemble the installation and start over again. Many radio frequency transmitters are constructed with a tapered base that extends downwardly. These bases are designed to mate to a tapered sleeve that is, in turn, secured to a supporting rod. If the tapered sleeve is installed inverted, the transmitter will not fit into the sleeve and the sleeve must to be removed and reinstalled. Thus, a desirable rod mount would be easily installed in only the proper orientation.

Radio frequency transmitters are exposed to the elements, most commonly in the form of moisture and humidity. The internal electronic components are sensitive and are prone to corrosion if not protected from the elements. Thus, cables that pass out of the radio frequency transmitter are usually sealed to the transmitter by a potting material. It is undesirable for stress to be put in these cables because that tends to break the seal between the cables and the transmitter and allow moisture and contaminants to enter the transmitter. It would be further desirable for a rod mount to protect these cables.

Thus, there is a need in the art for a simple and easy to use, secure means for securing radio frequency transmitters to rods for placement in utility meter pits.

### SUMMARY OF THE INVENTION

The present invention solves most of the above problems by providing a mounting bracket primarily adapted for mounting on a rod, tube or pole that is adaptable to installation on a wide variety of rod sizes, provides for a reliable 20 year mounting of radio frequency transmitters to a rod while utilizing no screws or other fasteners, thereby eliminating the possibility of loosening due to environmental extremes. Further, the present invention utilizes blind receptacles, which eliminates the need for secondary retention of the rod mount or the transmitter. It is self-orienting so that it can only be assembled in one way and it includes a sufficient collar depth to ensure secure retention and limitation of angular movement of the transmitter. The mounting bracket or collar is installed without the need for tools and has no loose parts to be misplaced or lost. Lastly, the mounting bracket or collar includes a cable notch which minimizes stress to the cable/potting joint of utility meter transmitters.

The mounting bracket or collar of the present invention generally comprises a cylindrical ring for holding an RF transmission module. The inside of the cylindrical ring is indented at two locations to provide a cable notch to minimize stress on the cable/potting juncture. Integrally secured to the transmitter cylinder are a series of blind receptacles of various sizes to accommodate installation on various size rods. The blind receptacles are substantially close at a top end. The top end need not be completely closed. The retention collar of the mounting bracket is of sufficient depth to ensure secure retention of the transmitter module and to limit angular movement of the transmitter module such that the transmitter module is kept sufficiently close to a level orientation to provide for optimum transmission of meter data to a remote receiver.

### BRIEF DESCRIPTION OF THE DRAWINGS

FIG. 1 is a perspective (bottom) view of the mounting bracket of the present invention;

FIG. 2 is a perspective (top) view of the mounting bracket;

FIG. 3 is a side perspective view of the mounting bracket of FIG. 1;

FIG. 4 is a top plan view of the mounting bracket of the present invention;

FIG. 5 is a cross-sectional view of the bracket taken along line 5-5 of FIG. 4;

FIG. 6 is a bottom plan view of the bracket of the present invention;

FIG. 7 is a schematic perspective view of a typical utility meter radio transmitter.

FIG. 8 is a first example of a substantially closed receptacle end

FIG. 9 is a second example of a substantially closed receptacle end;

FIG. 10 is a third example of a substantially closed receptacle end; and

FIG. 11 depicts the mounting bracket as installed in a meter pit with the meter pit shown in cross section.

### DETAILED DESCRIPTION OF THE INVENTION

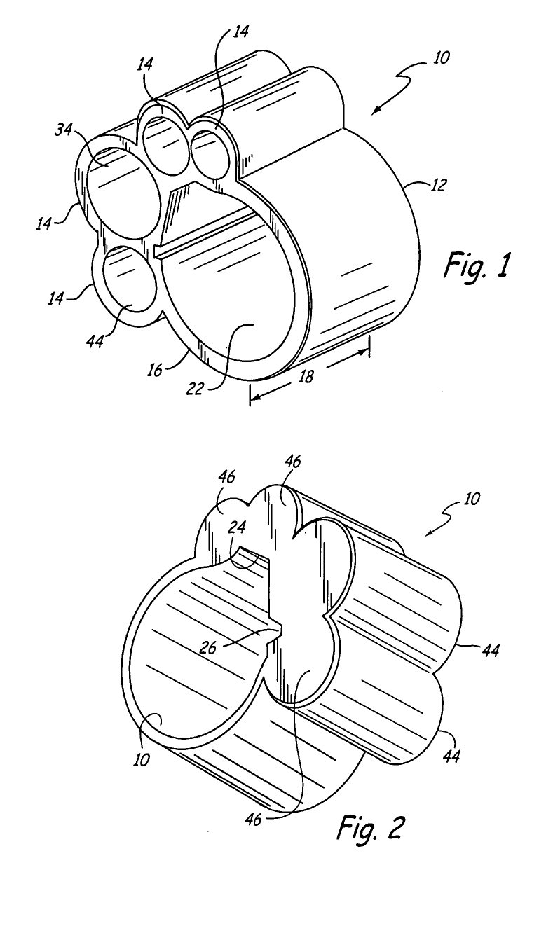

Referring to FIG. 1, a universal mounting bracket/retention collar 10 generally includes a support collar (or cylinder portion) 12 and a set of blind receptacles 14A-14D. Universal rod mount adapter/retention collar 10 (hereinafter “rod mount 10”) is desirably molded as a single integral unit but may be assembled in other ways. Rod mount 10 is preferably manufactured from a dielectric plastic but may be made of any durable weather resistant material (such as ceramic, aluminum, or steel).

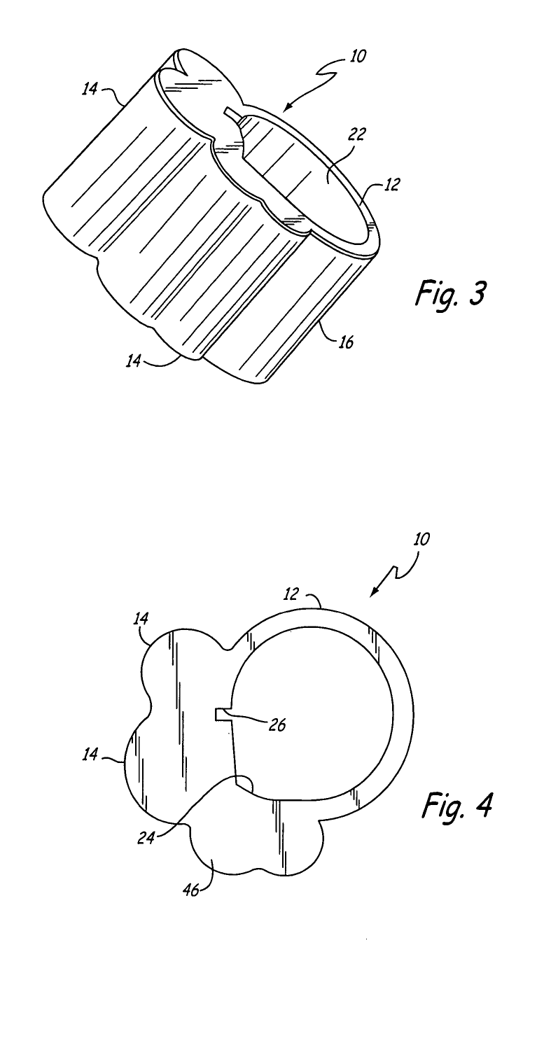

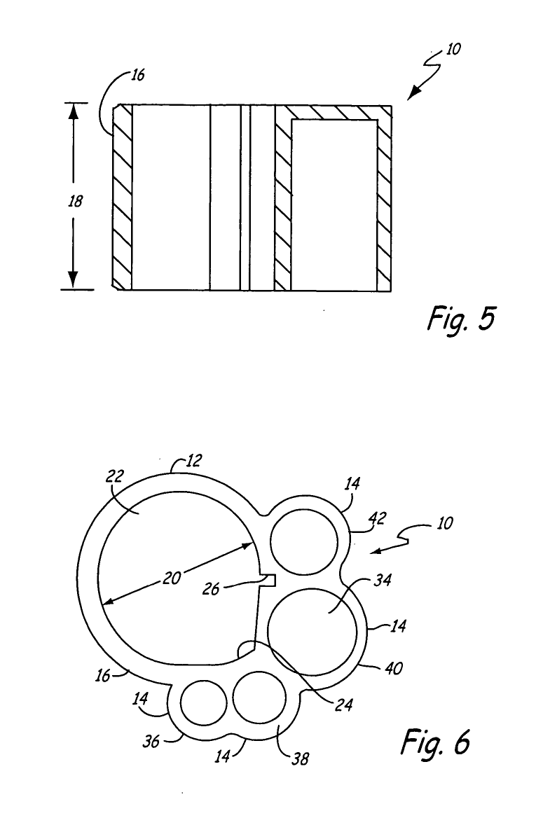

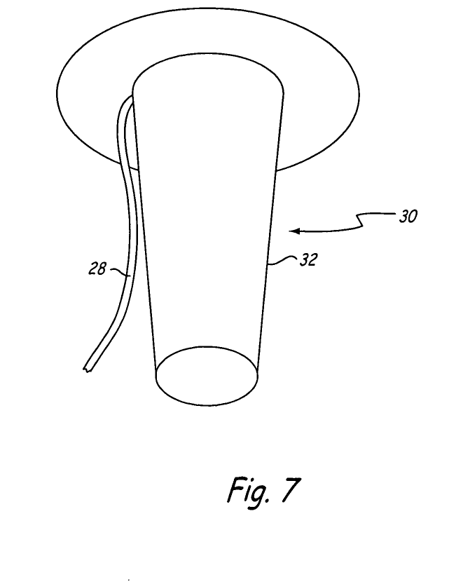

Support collar 12 as depicted in FIGS. 1-6 is a generally cylindrical structure defined by wall 16. The height 18 of wall 16 is roughly equal to internal diameter 20 of support collar 12. Wall 16 encircles radio transmitter support opening 22 and may be tapered to accept a tapered transmitter. Wall 16 also defines recessed area 24 and secondary recessed area 26.

Recessed area 24 and secondary recessed area 26 may run generally parallel to height 18 of wall 16. Recessed area 24 and secondary recessed area 26 are sized to accommodate the passage of cables 28 associated with radio transmitter 30. Radio transmitter support opening 22 is sized and shaped to accommodate radio transmitter body 32. As depicted here, radio transmitter support opening 22 is generally a circular cylinder, however, radio transmitter support opening 22 may be adapted to any shape required to accommodate a particular a radio transmitter 30.

Blind receptacles 14A-14D are integrally formed adjacent wall 16 with receptacle openings 34 on an opposite side of wall 16 from radio transmitter support opening 22. Desirably, there are four blind receptacles 14; however, there may be more or less blind receptacles 14 but preferably not less than two. Rod mount 10, as depicted here, includes four blind receptacles 14, first receptacle 36, second receptacle 38, third receptacle 40 and fourth receptacle 42.

Blind receptacles 14 vary in size with first receptacle 36 being the smallest and fourth receptacle 42 being the largest with second receptacle 38 and third receptacle 40 being intermediate in size and with third receptacle 40 being larger than second receptacle 38. Desirably, fourth receptacle 42 is located between third receptacle 40 and second receptacle 38. Desirably, first receptacle 36 has an inside diameter at receptacle opening 34 of approximately three-eighths inch. Second receptacle 38 has an opening of approximately one half inch. Third receptacle 40 has an opening of about five eighths of an inch and fourth receptacle 42 has an opening diameter of about seven eighths inch. The receptacle 14 can be varied in size and receptacle order if needed. Blind receptacles 14 are all open at a first end 44 and substantially closed at a second end 46. Blind receptacles 14 may taper slightly from being larger at first end 44 to being slightly smaller at second end 46.

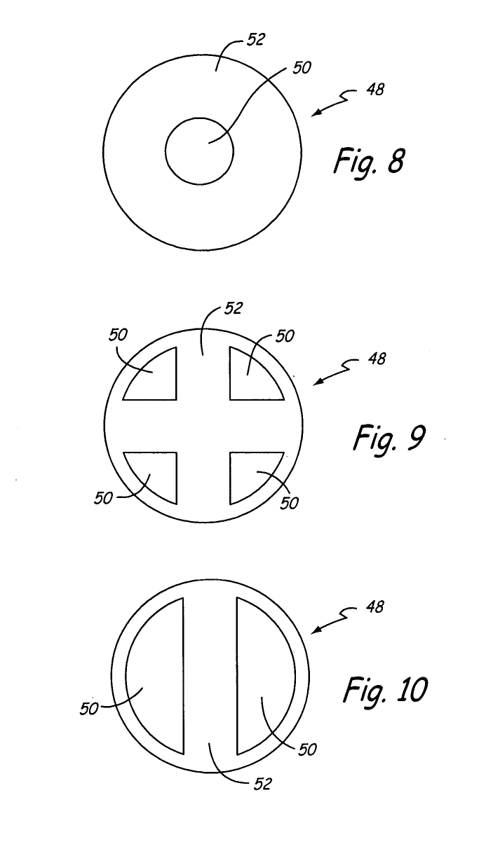

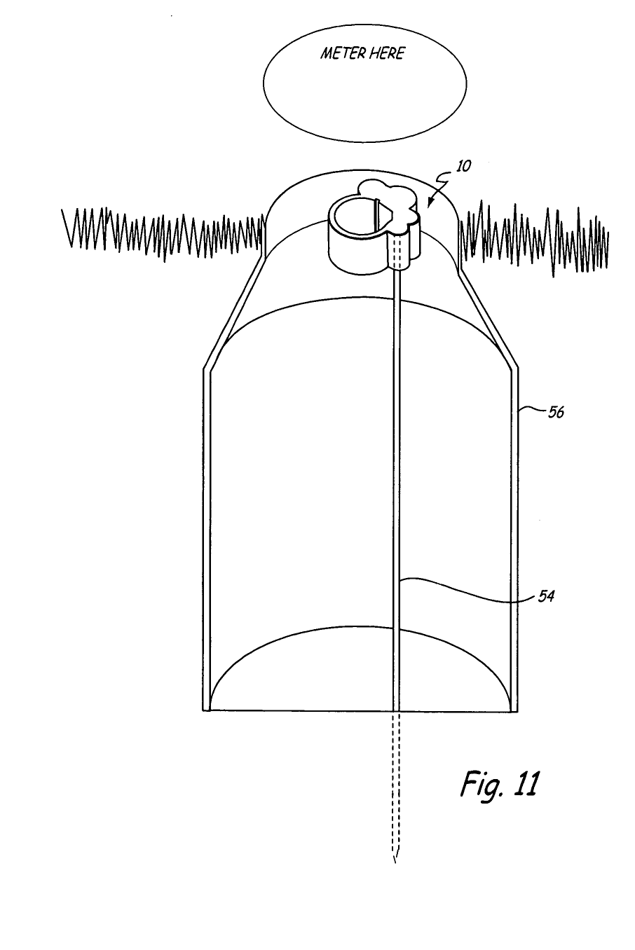

Blind receptacles 14 are substantially closed at their tops. Substantially closed, for the purposes of this application, means that the top of the blind receptacle 14 is closed sufficiently so that a rod passed into the open bottom of the blind receptacle 14 is prevented from passing out through the substantially closed top. Substantially closed includes a completely closed end as well as an end that is partially closed by structure and partially open. Examples of substantially closed receptacle tops 48 are shown in FIGS. 8, 9 and 10. Substantially closed receptacle tops 48 include open portions 50 and structural members 52.

In operation, referring to FIG. 11, rod mount 10 is placed on top of a rod 54 driven into the ground within a utility meter pit 56. The installer measures the diameter of an existing rod 54 or a rod 54 to be placed into the pit 56 and selects an appropriate sized receptacle opening 34. Receptacle opening 34 should be selected so that rod mount 10 is placed over the rod with the smallest receptacle that will fit over the rod.

If there is no existing rod 54 in the pit 56 the installer measures the depth of the pit 56 to determine the length of rod 54 needed. Then the installer cuts an appropriate length rod 54 and drives it into the soil that forms the floor of the pit 56. The installer then selects the appropriate receptacle opening 34 to receive the rod 54 therein.

The rod mount 10 is then placed on top of the rod. Once rod mount 10 is placed on a rod 54, radio transmitter 30 is inserted into support collar 12. While inserting radio transmitter body 32 into radio transmitter support opening 22 care is taken to place cables 28 within recessed area 24 or secondary recessed area 26, so that cables 28 are not pinched between radio transmitter body 32 and support collar 12. After verifying that the radio transmitter 30 is appropriately located, the installation is complete.

The configuration of support collar 12 is not limited to a cylindrical shape and can be formed to fit other shapes of mounting rods. In addition, the blind receptacles may be tapered internally to accommodate a mounting rod that is pointed or tapered.

The present invention may be embodied in other specific forms without departing from the spirit of the essential attributes thereof, therefore, the illustrated embodiments should be considered in all respects as illustrative and not restive, reference being made to the appended claims rather than to the foregoing description to indicate the scope of the invention.

1. A mounting bracket for mounting a radio frequency transmission module on one of a variety of rods or tubes, the rods or tubes varying in size, the radio frequency transmission module comprising a body portion and a head portion, the head portion being larger than the body portion, the mounting bracket comprising:
a walled receptacle for the module having an open top and an open bottom and dimensioned to accept the body portion therethrough while preventing the head portion from passing through;
at least two support member receptacles operably attached at the periphery of the walled receptacle, each support member receptacle being open at bottom thereof and substantially closed at a top thereof and each of the support member receptacles being of a different internal dimension from the other support member receptacles to facilitate the reception of the rod or tube therein; and
the mounting bracket being a unitary structure having no separable fasteners.

2. The mounting bracket as claimed in claim 1, in which the walled receptacle is generally cylindrical in shape.

3. The mounting bracket as claimed in claim 1, in which the walled receptacle wall defines at least one recess therein dimensioned to receive wires from said transmission module.

4. The mounting bracket as claimed in claim 1, in which each support member receptacle is configured so that its height is substantially greater than its width.

5. The mounting bracket as claimed in claim 1, in which at least one of the support member receptacles is generally cylindrical.

6. The mounting bracket as claimed in claim 1, in which at least one of the support member receptacles is tapered internally so as to be narrower near the closed top and wider near the open bottom thereof.

7. A mounting bracket for mounting a radio frequency transmission module on a rod or tube, comprising:
a substantially cylindrical walled receptacle having an open top and a bottom and dimensioned to receive a portion of the transmission module therethrough while preventing the passage of another larger portion of the transmission module;
at least two generally cylindrical support member receptacles attached to the module receptacle each being open at bottom thereof and substantially closed at a top thereof and each being of a different internal dimension; and
in which the mounting bracket is a unitary one piece structure that includes no separable fasteners.

8. The mounting bracket as claimed in claim 7, in which the walled receptacle wall defines at least one recess therein dimensioned to receive wires from said transmission module.

9. The mounting bracket as claimed in claim 7, in which each support member receptacle is configured so that its height is substantially greater than its width.

10. The mounting bracket as claimed in claim 7, in which at least one of the support member receptacles is tapered internally so as to be narrower near the closed top and wider near the open bottom thereof.

11. A method of mounting a radio frequency transmission module, the method comprising the steps of:
driving an elongate support member into a ground surface in a substantially vertical orientation;
providing a unitary one piece mounting bracket comprising a sleeve for the module having an open top and an open bottom and at least two support member receptacles operably attached at the periphery of the sleeve, each support member receptacle being open at bottom thereof and substantially closed at a top thereof and each of the support member receptacles being of a different internal dimension from the other support member receptacles to facilitate the reception of different sized elongate support members therein
selecting a support member receptacle to fit a size of the elongate support member;
inserting the radio frequency transmission module into the sleeve;
placing the mounting bracket onto the elongate member so that the elongate member is inserted into a bottom of one of the at least two support member receptacles so that the support member enters the support member receptacle through the open bottom and is prevented from passing through the support member receptacle by interference with the substantially closed top.

12. The method as claimed in claim 11, further comprising the step of forming the walled receptacle so that it is generally cylindrical in shape.

13. The method as claimed in claim 11, further comprising the step of forming the walled receptacle wall so that it defines at least one recess therein dimensioned to receive wires from said transmission module.

14. The method as claimed in claim 11, further comprising the step of forming each support member receptacle so that its height is substantially greater than its width.

15. The method as claimed in claim 11, further comprising the step of forming at least one of the support member receptacles so that it is generally cylindrical.

16. The method as claimed in claim 11, further comprising the step of forming at least one of the support member receptacles so that it is tapered internally so as to be narrower near the closed top and wider near the open bottom thereof.
